(19) United States
(12) Patent Application Publication
(10) Pub. No.: US 2014/0100918 A1
(43) Pub. Date: Apr. 10, 2014

(54) ANALYZING MARKET RESEARCH SURVEY RESULTS USING SOCIAL NETWORKING ACTIVITY INFORMATION

(71) Applicant: LIGHTSPEED ONLINE RESEARCH, INC., Warren, NJ (US)

(72) Inventors: Joel Lynn Rosenberger, Sammamish, WA (US); James Brian King, Vancouver (CA); Daniel Tak Yiu, Burnaby (CA)

(73) Assignee: LIGHTSPEED ONLINE RESEARCH, INC., Warren, NJ (US)

(21) Appl. No.: 13/646,630

(22) Filed: Oct. 5, 2012

(51) Int. Cl. G06Q 30/02

(52) U.S. Cl. 705/7.32

(57) ABSTRACT

A facility for analyzing market research survey results is described. Among a number of users who have responded to a market research survey, the facility selects users whose responses to the survey match a designated pattern of responses to the survey. The facility then generates output that identifies social networking actions performed by the selected users.

### BACKGROUND

In order to evaluate and guide the design and promotion strategy for a product or service, many companies use market research surveys. In a market research survey, a set of questions is posed to each of a number of people, called “respondents.” Survey questions are often directed to the respondent's personal tastes, behaviors, and preferences as they relate to the product or service. The responses to a survey's questions, aggregated across its respondents, is typically used as an estimate of how a much larger population, such as the population of all possible customers for the product or service in a particular geographic region, would in the aggregate answer the survey's questions.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing how the facility collects and transforms data in order to analyze market research survey results using social networking activity information.

FIG. 3 is a flow diagram showing steps typically performed by the facility in order to register a new user as a panel member with the operator of the facility.

FIG. 4 is a table diagram showing sample contents of a demographic attribute table used by the facility in some embodiments to store demographic attributes received for panel members.

FIG. 5 is a flow diagram showing steps typically performed by the facility in order to register a panel member for social networking action exporting.

FIG. 6 is a flow diagram showing steps typically performed by the facility in order to receive social networking actions exported from the social network platform.

FIG. 7 is a table diagram showing typical sample contents of a survey response table used by the facility in some embodiments.

FIG. 8 is a flow diagram showing steps typically performed by the facility in some embodiments in order to conduct a particular survey with a particular panel member.

FIG. 9 is a table diagram showing typical sample contents of a survey response table used by the facility to store panel members' survey responses in some embodiments.

FIG. 10 is a flow diagram showing steps typically performed by the facility when the export of social networking actions is triggered for a particular user.

FIG. 11 is a flow diagram showing steps typically performed by the facility in some embodiments in order to refresh the exported social networking actions each time the app is launched on the social networking platform.

FIG. 12 is a flow diagram showing steps to be performed by the facility in order to characterize results of a survey in some embodiments.

FIG. 13 is a user interface diagram showing a sample report generated by the facility in step 1203 in some embodiments.

FIG. 14 is a flow diagram showing steps typically performed by the facility in order to select users to participate in a survey based upon their social networking activity.

### DETAILED DESCRIPTION

The inventors have recognized that the companies who consume market research surveys could benefit from additional information about the survey respondents who respond to their surveys in particular ways. This information can be used to better understand survey responses, as well as to identify the best ways to advertise to customers similar to these respondents, such as what form of advertising to use, what advertising outlets to use, how to design the advertising, etc.

Accordingly, the inventors have designed a software and/or hardware facility that analyzes market research survey results using social networking activity information (“the facility”) as described herein.

A group of people called a “panel” are enlisted as prospective survey respondents. Each person is queried about demographic attributes, such as sex, age, occupation, income level, geographic location, ethnicity, etc., and these demographic attributes are stored for the person. Each person is also invited to grant access to information about their activities on a third-party social networking platform, such as Facebook, Google+, Myspace, LinkedIn, Twitter, Ning, Meetup, Orkut, etc. They may grant such access by installing an application on the social networking platform that provides access to this information. These activities can include, for example, joining groups, or declaring an interest in or approval of a subject, such as by “liking” a subject, or “friending” a user associated with the subject, including synthetic users. The granted access is used to periodically or continuously retrieve the activity information and store it together with the person's demographic attributes. When people about whom this information is stored respond to a particular survey, the demographic and activity information can be used together to characterize, among the people who took the survey, those who responded in a particular way, such as by responding in a way that indicates that they have the desire and means to purchase a particular product. For example, this subset of the survey respondents can be characterized by identifying a most common age range among them (using the demographic information), as well as the three subjects for which they most commonly declared approval (using the activity information). This characterization can be used to target advertising for the product.

In some embodiments, a facility uses social networking actions of users as a basis for selecting them to participate in a particular survey. As an example, where only a subset of the users of the panel have performed a “like” action with respect to a subject relating to a client's product, the facility selects the users of the panel who have not performed the like action with respect to the subject to participate in a survey relating to the subject. For example, the survey may seek to determine how of each of these users regards the subject, why each of these users has not “liked” the subject, etc.

By performing in some or all of these ways, the facility enables a client who commissioned a market research survey to obtain greater value from the results, such as by identifying advertising strategies for a product or service that are likely to be an effective way to reach the product or service's target market.

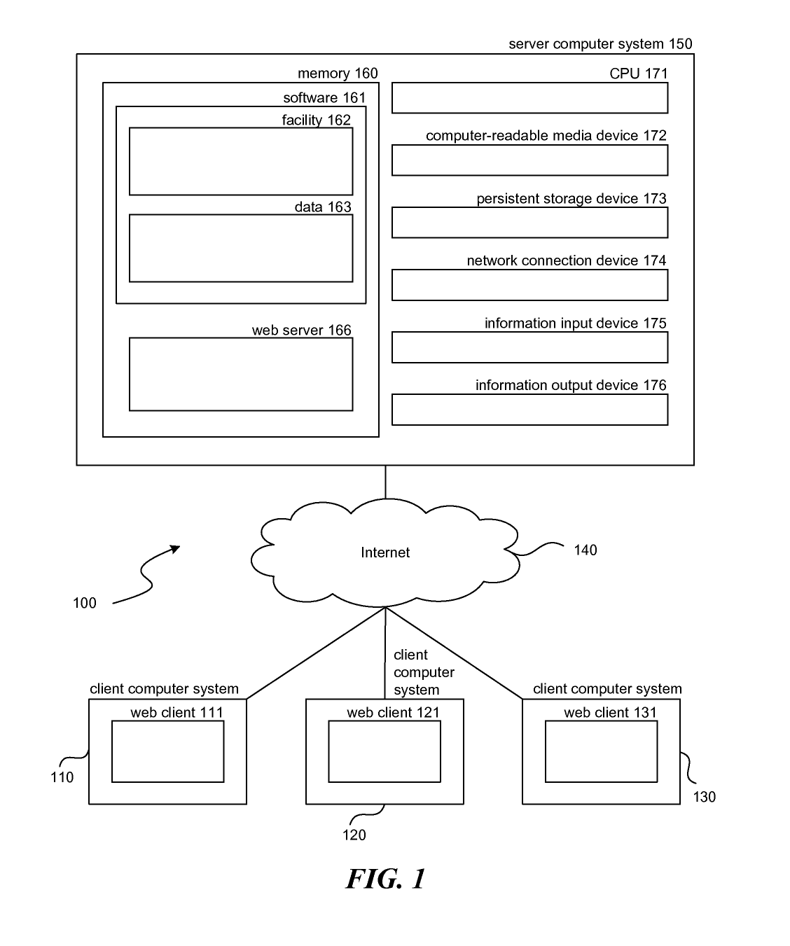

FIG. 1 is a high-level block diagram showing a typical environment 100 in which a software, hardware, and/or firmware facility implementing the functionality described herein operates in some embodiments. The block diagram shows a server computer system 150. The server computer system 150 includes a memory 160. The memory 160 includes software 161 incorporating both the facility 162 and data 163 typically used by facility. The memory further includes a web server computer program 166 for providing web pages and/or other information to other computers. While items 162 and 163 are stored in memory while being used, those skilled in the art will appreciate that these items, or portions of them, maybe be transferred between memory and a persistent storage device 173 for purposes of memory management, data integrity, and/or other purposes. The server computer system 150 further includes one or more central processing units (CPU) 171 for executing programs, such as programs 161, 162, and 166, and a computer-readable medium drive 172 for reading information or installing programs such as the facility from tangible computer-readable storage media, such as a floppy disk, a CD-ROM, a DVD, a USB flash drive, and/or other tangible computer-readable storage media. The computer system 150 also includes one or more of the following: a network connection device 174 for connecting to a network (for example, the Internet 140), an information input device 175, and an information output device 176.

The block diagram also illustrates several client computer systems, such as client computer systems 110, 120, and 130. Each of the client computer systems includes a web client computer program, such as web clients 111, 120, and 131, for receiving web pages and/or other information in response to requests to web server computer programs, such as web server computer program 166. The client computer systems are connected via the Internet 140 or a data transmission network of another type to the server computer system 150. Those skilled in the art will recognize that the client computer systems could be connected to the server computer system 150 by networks other than the Internet, however.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, cameras, etc.

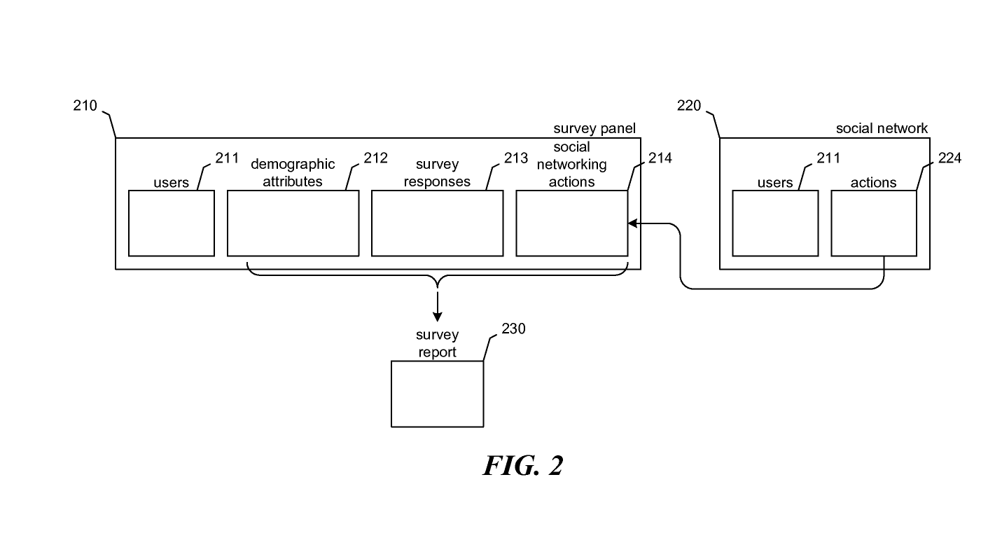

FIG. 2 is a data flow diagram showing how the facility collects and transforms data in order to analyze market research survey results using social networking activity information. A survey panel data store 210 is shown. In some embodiments, the survey panel data structure is stored by and/or hosted on behalf of the operator of the facility. The survey panel data store includes information 211 about users who are members of a research panel, including their user identifiers, email address, other external identifiers for the users, password, panel member status, information about the status of their pay or other rewards in return for participating in surveys, etc. The survey panel data store further includes demographic attribute information 212 for the users, including age, race, sex, geographic location, income, educational status, etc. The survey panel data store further includes survey response information 213. The survey response information includes answer, or “responses,” given by each user in response to individual questions and surveys that the user has completed. The survey responses information 213 can further contain other information about each respondent's completion of a survey, such as the time and date at which the survey was completed, the total amount of time spent completing the survey and/or the amount of time spent completing each question, etc.

The survey panel data store also includes social networking actions 214 performed by panel members as part of their participation in a social network, such as one or more of Facebook, Google+, Myspace, LinkedIn, Twitter, Ning, Meetup, Orkut, etc. These social networking actions are stored in the survey panel data store as the result of their export from the social network in which they were performed. In some embodiments, the export of these actions 224 from the social network is performed using an API or other explicit interface provided by the social network. In some embodiments, the export is performed by an app made available by the operators of the facility for installation and execution in the social network platform by the panelists, as is further discussed in more detail below. In various embodiments, the social networking actions exported from the social network include combinations of the following: an action asserting approval or disapproval of a specified subject, such as “liking,” or “+1-ing,” or visiting a company node, a product node, a category node, or an idea node within the social network; an action withdrawing a former assertion of approval of a specified subject; an action rating a specified subject; and action establishing (such as “friending” or “adding to a circle”) or cancelling a relationship with a user that in turn relates to a particular subject; an action posting a message to a forum relating to a particular subject; an action joining, visiting, or unjoining a group related to a particular subject; or other similar kinds of actions.

As is described in greater detail below, the facility uses some or all of the demographic attributes, survey responses, and social networking actions stored in the survey panel data store in order to generate a survey report 230 that includes information such as demographic attributes and/or social networking actions by particular respondents who responded to a survey in a way that matches a pattern of responses, such as a pattern of responses tending to identify respondents as likely purchasers of a product or service that is the subject of the survey.

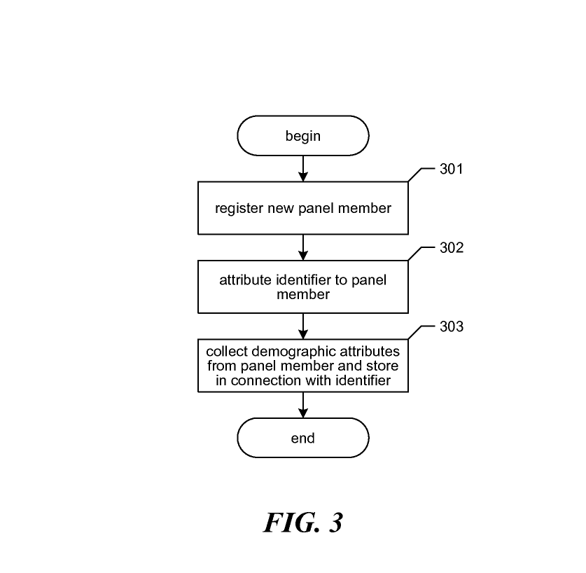

FIG. 3 is a flow diagram showing steps typically performed by the facility in order to register a new user as a panel member with the operator of the facility. In step 301, the facility receives input, such as a visit to a website operated by the operator of the facility, that indicates a user wishes to register as a panel member. In step 302, the facility attributes an internal identifier to the panel member that will be used by the facility to identify the new panel member. In step 303, the facility collects demographic attributes from the new panel member and stores them in connection with the new panel member's identifier. After step 303, these steps conclude.

Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

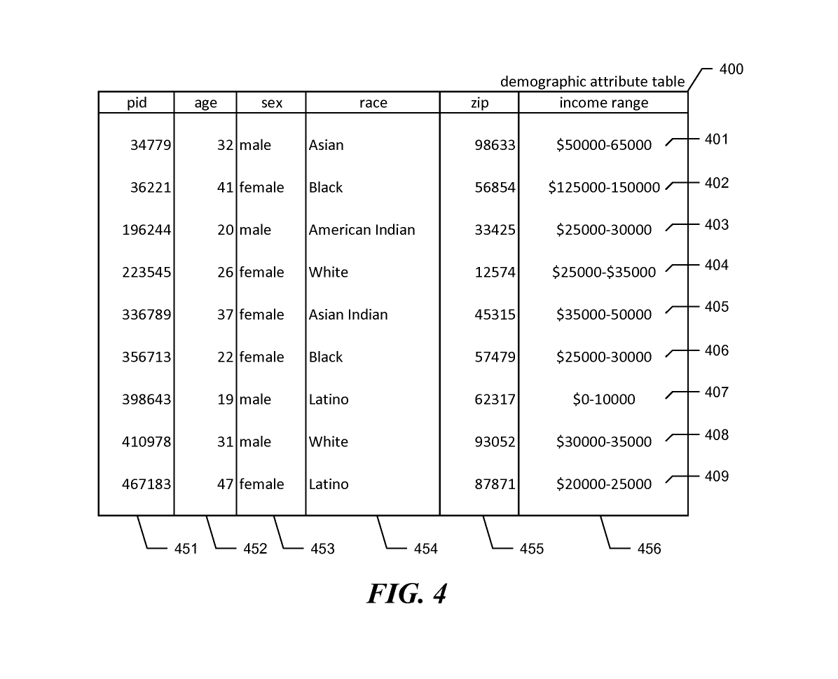

FIG. 4 is a table diagram showing sample contents of a demographic attribute table used by the facility in some embodiments to store demographic attributes received for panel members. The demographic attribute table 400 is made up of rows, such as rows 401-409, each divided into the following columns: a PID column 451 containing the internal panel member identifier for the panel member to whom the row relates; an age column 452 indicating the panel member's age; a sex column 453 indicating the panel member's sex, a race column 454 indicating the panel member's race; a zip code column 455 containing the panel member's zip code; and an income range column 456 indicating a range of amounts into which the panel member's falls. For example, row 401 indicates that the panel member having internal identifier 34779 is 32 years old, is male, is Asian, lives in the zip code 98633, and has an income in the range between $50,000 and $65,000.

While FIG. 4 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; may contain a much larger number of rows than shown, etc.

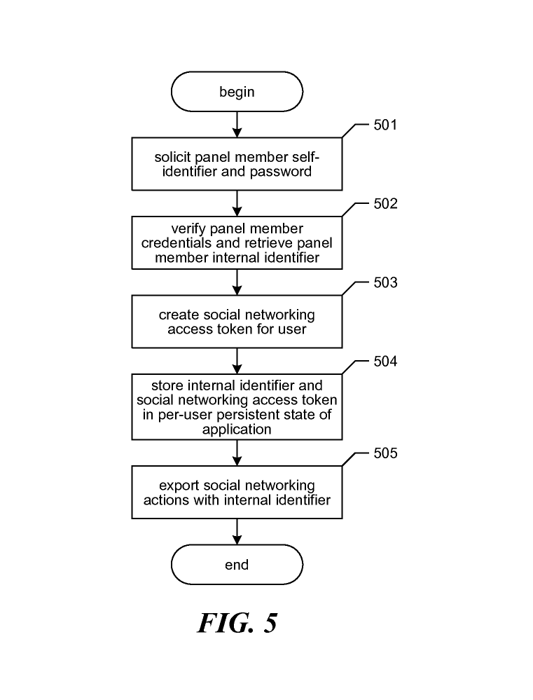

FIG. 5 is a flow diagram showing steps typically performed by the facility in order to register a panel member for social networking action exporting. These steps are typically performed by an app that is installed and executed within the social network platform by the panel member. In step 501, the facility solicits the identifier used by the panel member to self-identify a panel member to the operator of the facility, plus the password or other credentials provided to the panel member by the operator of the facility. In some cases, the self-identifier is an email address used by the panel member. In step 502, a facility member verifies the panel member credentials received in step 501 and retrieves a panel member internal identifier used by the operator of the facility to identify this panel member. In step 503, the facility creates a social networking access token in the social network platform for the user. In some embodiments, the facility uses an API provided by the operator of the social network platform for this purpose. For example, on the Facebook social network platform, in some embodiments the facility uses a server-side authentication process described at http://developers.facebook.com/docs/authentication/server-side to generate an access token. In step 504, the facility stores the retrieved internal identifier and created social networking access token in per-user persistent state of the application that will be available whenever this user of the social network platform launches the app. In step 505, the facility exports social networking actions performed by this user of the social network platform, along with the retrieved internal identifier, to the survey panel data store. After step 505, these steps conclude.

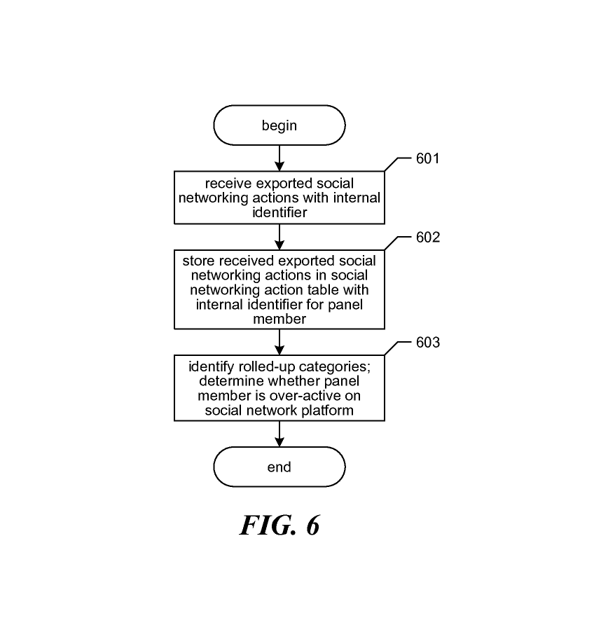

FIG. 6 is a flow diagram showing steps typically performed by the facility in order to receive social networking actions exported from the social network platform. In step 601, the facility receives social networking actions, along with an internal panel member identifier, exported from the social network platform by the app. In step 602, the facility stores the received exported social networking actions in a social networking action table with the internal identifier for the panel member who performed the social networking actions. In step 603, the facility augments the social networking actions stored in step 602. In some embodiments, the facility identifies, for each action, a “rolled-up category” or supercategory of the action's category, that is, it identifies in more general characterization of the category into which other related categories also fall. Also in step 603 the facility determines whether the panel member is over-active on the social network, or an “outlier.” In some cases, the facility does not report or qualifies social networking actions performed by panel members determined to be outliers. In some embodiments, the facility does so by determining whether the user has performed more than a threshold number of actions on the social network platform, such as a number that is three standard deviations above the mean number of actions performed on the social networking platform. In some embodiments, the facility performs filtering of certain rows, such as rows representing certain omitted action types, and/or rows representing actions performed with respect to certain omitted subjects, in some cases including subjects closely related to the operator of the facility. After step 603, these steps conclude.

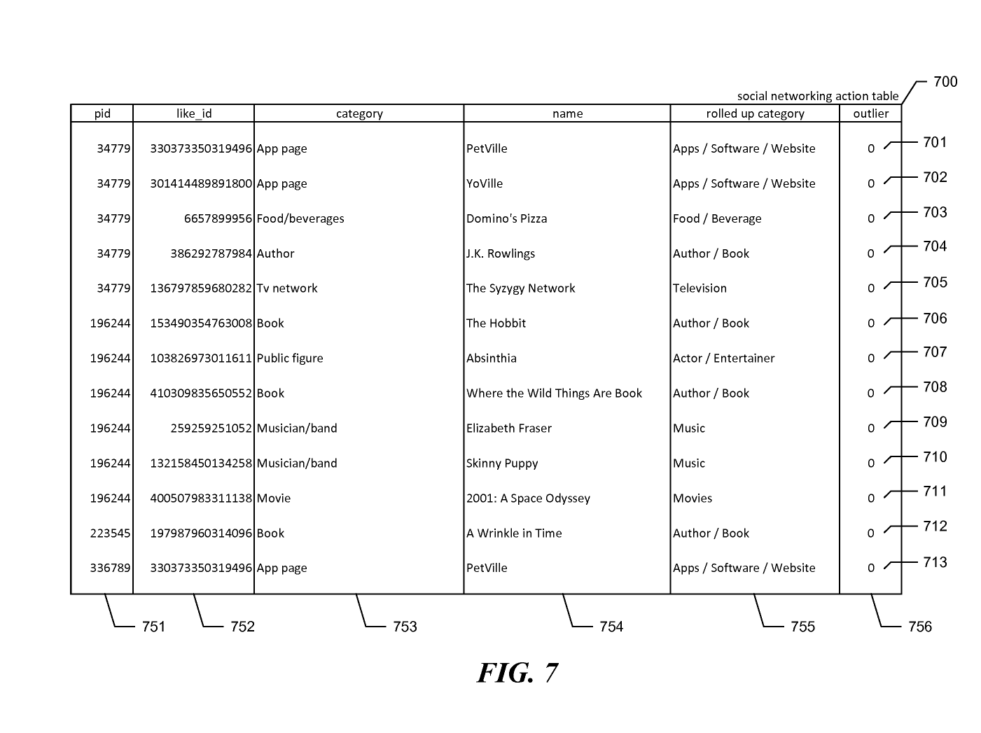

FIG. 7 is a table diagram showing typical sample contents of a survey response table used by the facility in some embodiments. The survey response table 700 is made up of rows, such as rows 701-713, each divided into the following columns: PID column 751 containing the internal identifier for the panel member who performed the social networking action; a like_ID column 752 containing an identifier for the action performed by the panel member; a category column 753 identifying a category into which the performed action falls; a name column 754 containing a name for the particular action performed; a rolled up category column 755 containing an indication of a “rolled up” category or supercategory of which the category is a member; and an outlier column 756 that indicates whether the user has performed so many social networking actions that the user should be considered an outlier, for purposes of interpreting the user's social networking actions, such as by discounting or completely ignoring the user's performance of the action. For example, row 701 indicates that the panel member having internal identifier 34779 performed action 330373350319496, having the name “PetVille,” category “App Page,” and the rolled-up category “Apps/Software/Website.” This user has not been determined to be an outlier. While the sample survey response table shown in FIG. 7 contains only “like” actions, in various embodiments, the facility includes various other kinds of actions among those exported from the social network platform and added to the survey response table.

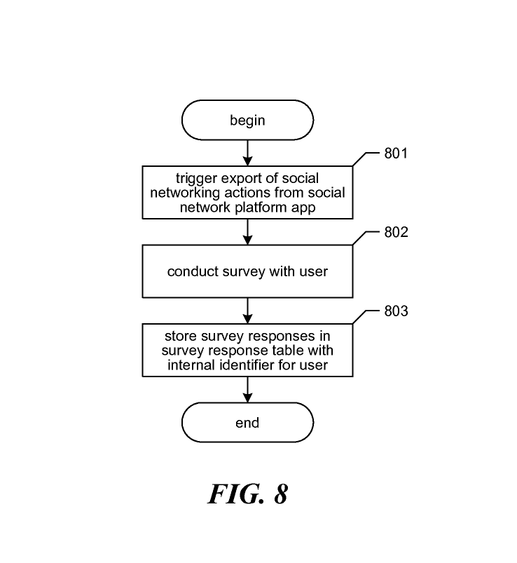

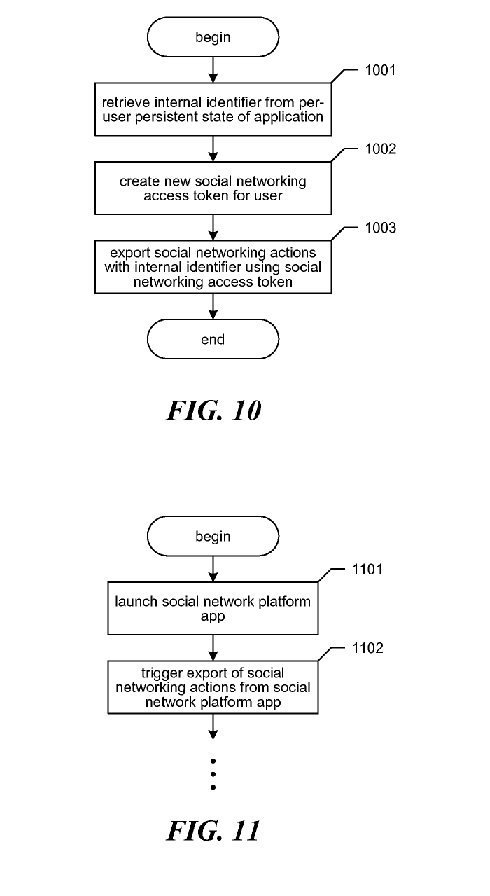

FIG. 8 is a flow diagram showing steps typically performed by the facility in some embodiments in order to conduct a particular survey with a particular panel member. In step 801, when a user elects to take a survey available to the user, the facility triggers the export of social networking actions from the social network platform application, causing it to perform the step shown in FIG. 10 and described in detail below. In response to the exporting of the social networking actions, the facility performs the steps of FIG. 6. In step 802, the facility conducts the survey with the user, presenting survey questions in the order specified by the survey, and prompting the user to supply an answer to each question that is among a set of possible answers. In step 803, the facility stores the survey responses provided by the panel member in the survey response table with the internal identifier for the user. After step 803, these steps conclude.

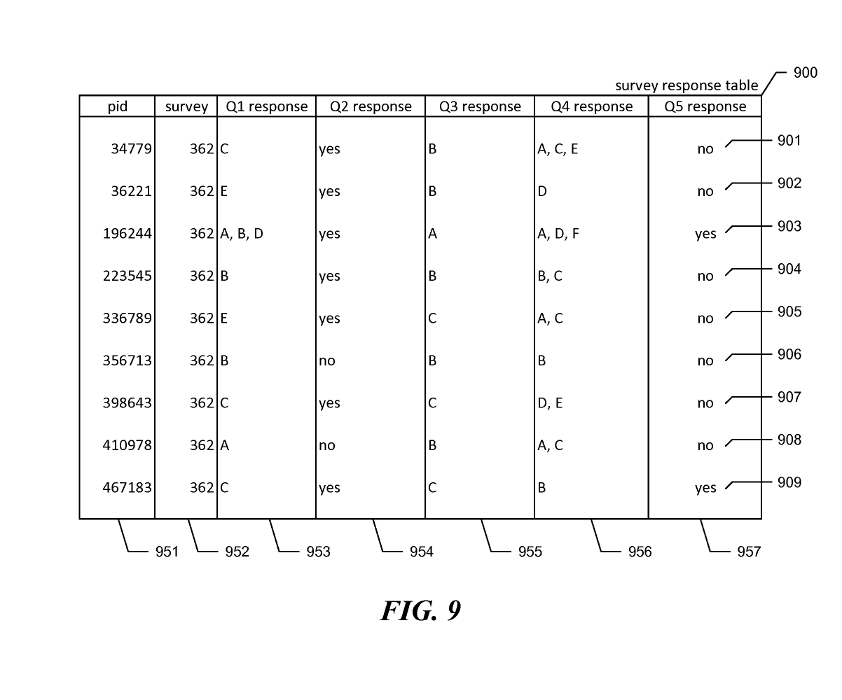

FIG. 9 is a table diagram showing typical sample contents of a survey response table used by the facility to store panel members' survey responses in some embodiments. The survey response table 900 is made up of rows, such as rows 901-909, each divided into the following columns: A PID column 951 containing internal identifier for the panel member who completed the survey; a survey column 952 which contains an identifier for the survey completed; and question response columns 953-957 which each contain the panel member's response to a different one of the questions making up the survey. For example, row 901 indicates that the panel member having internal identifier 34779 completed survey number 362, and gave the answer “C” to question 1, the answer “yes” to question 2, the answer “B” to the third question, the answer “A, C, E” to the fourth question, and the response “no” to the fifth question.

FIG. 10 is a flow diagram showing steps typically performed by the facility when the export of social networking actions is triggered for a particular user. In some embodiments, these steps are performed in response to the triggering of exporting social networking actions in step 803 of FIG. 8 discussed above, or in step 1102 of FIG. 11 discussed below. In some embodiments, these steps are performed by the app executed on the social network platform. In step 1001, the facility retrieves the internal identifier of the panel member that corresponds to the user of the social network platform and is stored in per-user persistent state of the app. In step 1002, the facility creates a new social networking access token for the user. In step 1003, the facility uses the social networking access token to export the social networking actions along with retrieved internal identifier. In some embodiments, the facility uses an API exposed by the social network platform for exporting social networking actions and other user information. As an example, in some embodiments, for the social network platform Facebook, the facility uses a public Graph API provided by Facebook and documented at http://developers.facebook.com/docs/reference/api. In some embodiments, step 1003 is performed by a computer system under the control of the operators of the facility that is separate from the computer systems on which the social network platform runs, instigated to do so by a received asynchronous message sent to the computer system under the control of the operators of the facility in response to a triggering event. The exported social networking actions may be the same of those exported before; may be cumulative to those exported before; or may, at least to a certain degree, contradict those exported before. In some embodiments, the facility selects a subset of the social networking actions performed by the user in the platform for export, using one or more of the following bases: whether the action was performed more recently than a threshold amount of time; whether the action is among certain selected action types; whether the action was performed with respect to certain selected subjects; etc. The facility typically performs the steps shown in FIG. 6 in response to the exporting performed in step 1003. After step 1003, these steps conclude.

FIG. 11 is a flow diagram showing steps typically performed by the facility in some embodiments in order to refresh the exported social networking actions each time the app is launched on the social networking platform. In step 1101, the user of the social network platform launches the app. In step 1102, the facility triggers the export of social networking actions from the app as described above. While the steps following step 1102 are not shown, they may include permitting the user to complete surveys as part of the research panel, access information about surveys completed, review the opportunity to complete additional surveys, review credit, compensation, or prizes provided in exchange for completing the surveys, etc.

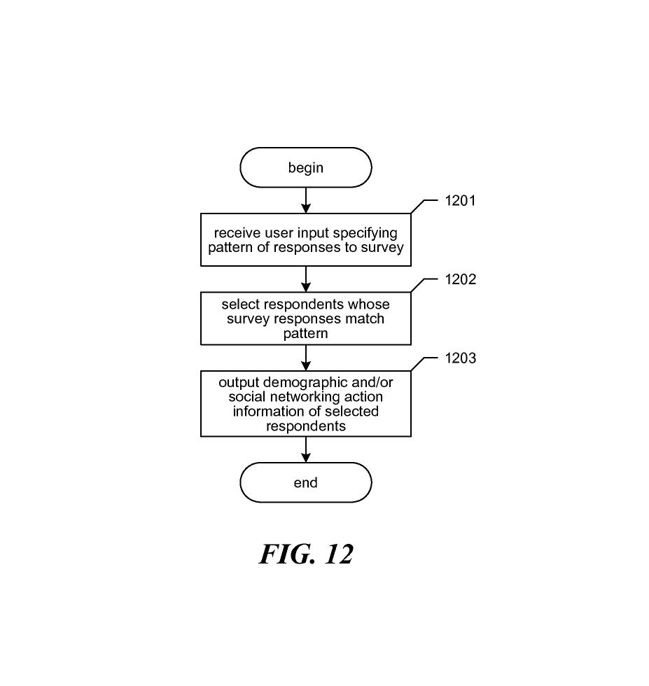

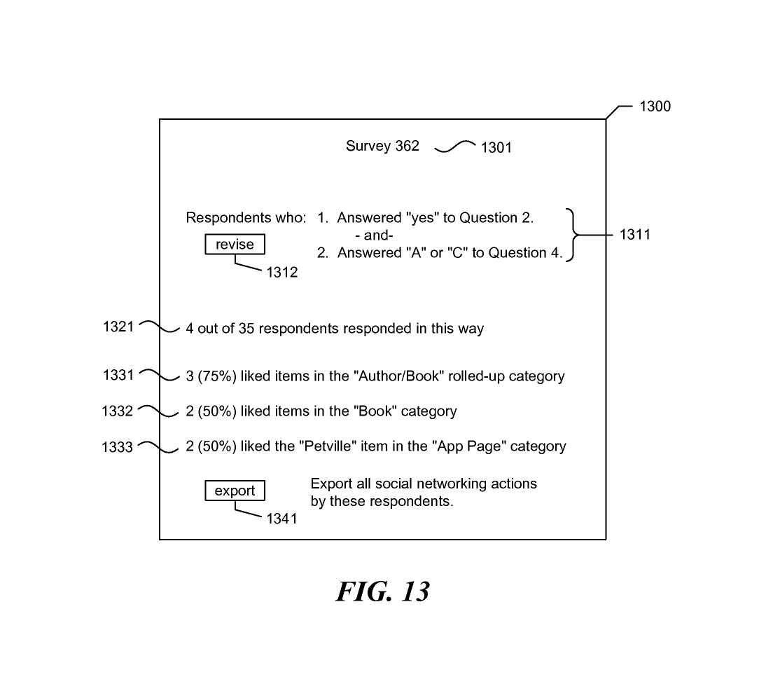

FIG. 12 is a flow diagram showing steps to be performed by the facility in order to characterize results of a survey in some embodiments. In step 1201, the facility receives user input specifying a pattern of responses to a particular survey. For example, the facility in step 1201 may receive user input identifying survey 6392 and specifying the following pattern of responses: answering “yes” to question 2 and answering “A” or “C” to question 4. In step 1202, the facility selects respondents whose survey responses match the pattern received in step 1201. Continuing the example above, from the survey response table 900 shown in FIG. 9, the facility would select the respondents having internal identifiers 34779, 196244, 223545, and 336789 based upon the responses shown in rows 901, 903, 904, 905 and columns 954 and 956. In step 1203, the facility outputs demographic and/or social networking action information of the respondents selected in step 1202. A sample report generated by the facility in step 1203 is shown below in FIG. 13. In some embodiments, however, the facility simply exports, such as in a spreadsheet, some or all of the contents of the demographic attribute table 400 shown in FIG. 4 and/or the social networking table 700 shown in FIG. 7 for the selected users. After step 1203, these steps conclude.

FIG. 13 is a user interface diagram showing a sample report generated by the facility in step 1203 in some embodiments. Report 1300 contains information 1301 identifying a particular survey, and a response pattern 1311 that has been specified for the survey, such as to identify panel members who are likely to be customers for a product or service to which the survey corresponds. The report also contains a revise control 1312 that the user viewing the report can activate in order to change the response pattern identified in section 1311, and update the report accordingly. The report further contains indication 1321 of the share of respondents to the survey whose responses match this pattern, in this case 4 out of 35 respondents. The report further contains indications 1331-1333, each of a different action, subject, category, or supercategory that is represented to a significant degree among the selected respondents who responded in accordance with the pattern. In some embodiments, these are determined by the facility simply based upon the frequency with which the selected users have performed these actions. In some embodiments, the facility employs various information retrieval techniques in order to find actions performed by selected panel members that tend to distinguish the selected panel members from those who completed the survey in a way that does not match the pattern. In such embodiments, the facility identifies actions performed frequently by the selected panel members completing the survey that were performed infrequently by the panel members completing the survey who were not selected. The report also contains an export control 1341 that the user can activate in order to export, such as in a spreadsheet, all of the social networking actions performed by the selected respondents.

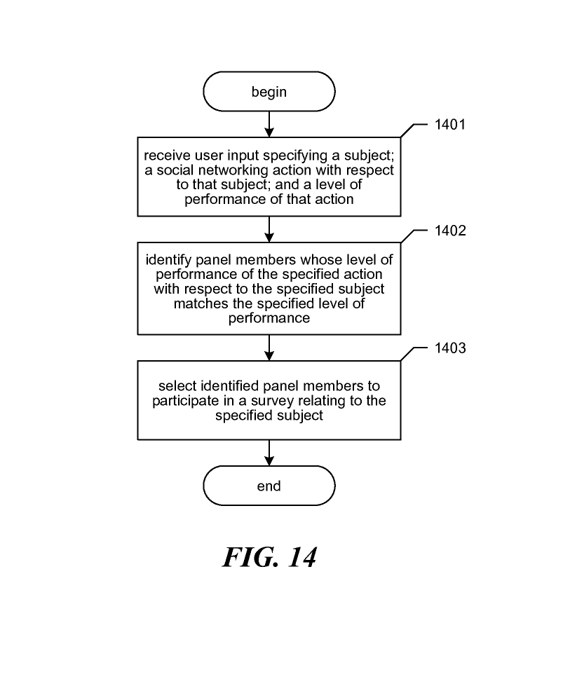

FIG. 14 is a flow diagram showing steps typically performed by the facility in order to select users to participate in a survey based upon their social networking activity. In step 1401, the facility receives user input that specifies some or all of the following information: a subject; one or more social networking actions that relate to that subject; and a level of performance of those social networking actions. In one example, the facility receives input specifying the subject of a particular brand of floor cleaning product; the social networking action of “liking” the floor cleaning product; and the level of performance of never having performed that action. In step 1402, the facility identifies members of the panel whose level of performance the specified action with respect to the specified subject matches the specified level of performance. To continue the example, the facility selects any user who has not “liked” the floor cleaning product. In step 1403, the facility selects the panel members identified in step 1402 to participate in a survey, such as a survey that relates to the specified subject. To continue the example, the facility selects the panel members who have not “liked” the floor cleaning product to participate in this survey relating to the floor cleaning product. After step 1403, these steps conclude.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. (canceled)

2. A computer-readable storage medium storing contents adapted to cause a computing system to perform a method for analyzing market research survey results, the method comprising:
among a plurality of users who have responded to a distinguished market research survey, selecting users whose responses to the distinguished market research survey match a designated pattern of responses to the distinguished market research survey;
identifying one or more social networking actions that tend to distinguish selected users of the plurality from users of the plurality not selected; and
generating output characterizing the selected users of the plurality in terms of the identified social networking actions.

3. The computer-readable storage medium of claim 2 wherein the method further comprises:
identifying one or more demographic attributes that tend to distinguish selected users of the plurality from users of the plurality not selected,
and wherein the generating generates output that also characterizing the selected users of the plurality in terms of the identified demographic attributes.

4. The computer-readable storage medium of claim 2 wherein the generating generates output that also identifies the designated pattern of responses.

5. The computer-readable storage medium of claim 2 wherein the generating generates output that also indicates the number of selected users.

6. The computer-readable storage medium of claim 2 wherein the generating generates output that also indicates the percentage of the plurality of users that were selected.

7. The computer-readable storage medium of claim 2 wherein the pattern of responses comprises a particular response to a particular survey question.

8. The computer-readable storage medium of claim 2 wherein the pattern of responses comprises a particular a proper subset of possible answers to a particular survey question.

9. The computer-readable storage medium of claim 2 wherein the pattern of responses comprises a particular a proper subrange of a range of possible answers to a particular survey question.

10. The computer-readable storage medium of claim 2 wherein the pattern of responses comprises, for each of a plurality of survey questions, a particular response to the survey question.

11-14. (canceled)

15. A method in a computing system for supporting analysis of market research survey results based on actions taken by users on a social network platform, comprising:
in a computing system under the control of an operator of the social network platform, in response to invocation of an application on the social network platform by a user:
determining a set of social networking actions taken by the user on the social network platform; and
transmitting the determined set of social networking actions together with an identifier usable to match the user with a member of a market research survey panel to a computing system not under the control of the operator of the social network platform,
such that, when the transmission is received at the computing system not under the control of the operator of the social network platform, the identifier can be used to identify a member of a market research survey panel to whom the user corresponds, and the determined set of social networking actions can be associated with the identified member of a market research survey panel.

16. The method of claim 15, further comprising:
in a computing system under the control of an operator of the social network platform, in response to invocation of the application on the social network platform by the user:
soliciting from the user and receiving from the user an identifier by which the user identifies himself or herself to an organizer of the market research survey panel; and
storing the received identifier in per-user persistent state of the application, and wherein the transmitted identifier is the stored identifier.

17. The method of claim 15 wherein the determined set of social networking actions includes an action asserting approval of a specified subject.

18. The method of claim 15 wherein the determined set of social networking actions includes an action withdrawing an assertion of approval of a specified subject.

19. The method of claim 15 wherein the determined set of social networking actions includes an action asserting disapproval of a specified subject.

20. The method of claim 15 wherein the determined set of social networking actions includes an action rating a specified subject.

21. The method of claim 15 wherein the determined set of social networking actions includes an action establishing a relationship with a user relating to a particular subject.

22. The method of claim 15 wherein the determined set of social networking actions includes an action canceling a relationship with a user relating to a particular subject.

23. The method of claim 15 wherein the determined set of social networking actions includes an action posting a message to a forum relating to a particular subject.

24. The method of claim 15 wherein the determined set of social networking actions includes an action joining a group relating to a particular subject.

25. The method of claim 15 wherein the determined set of social networking actions includes an action leaving a group relating to a particular subject.

26-28. (canceled)

29. A computer-readable storage medium storing a survey result structure, the data structure comprising:
for a distinguished market research survey, for a group of respondents who all responded to the distinguished market research survey in a particular way, one or more entries each identifying an action on a social network platform whose performance is common among respondents of the group,
such that the contents of the data structure can be used to correlate survey responses with social network actions.

30. A method in a computing system for conducting market research, comprising:
receiving input specifying a social networking action and a level of performance of the specified social networking action;
for each of a plurality of users, determining whether the user performed the specified social networking action on a social network platform at a level that matches the specified level of performance; and
of the plurality of users, selecting for participation in a distinguished survey those who are determined to have performed the specified social networking action at a level that matches the specified level performance.

31. The method of claim 30 wherein the specified action is specified with respect to a particular subject, and wherein the distinguished survey relates to that subject.

32. The method of claim 30 further comprising:
causing information about the social networking actions performed by the plurality of users on the social network platform to be exported from the social network platform.

33. The method of claim 30 wherein the specified level of performance is performing the action at least a distinguished number of times.

34. The method of claim 30 wherein the specified level of performance is performing the action at least a distinguished number of times within a distinguished period of time.

35. The method of claim 30 wherein the specified level of performance is performing the action no more than a distinguished number of times.

36. The method of claim 30 wherein the specified level of performance is performing the action no more than a distinguished number of times within a distinguished period of time.

37. The method of claim 30, further comprising, for each of at least a portion of the selected users, directing to the selected user an invitation to participate in the distinguished survey.

38. The method of claim 30, further comprising, for each of at least a portion of the selected users, administering the distinguished survey to the selected user.

39-41. (canceled)
